(19) United States
(12) Patent Application Publication
(10) Pub. No.: US 2020/0258021 A1
(43) Pub. Date: Aug. 13, 2020

(54) INFORMATION PROCESSING DEVICE, INFORMATION PROCESSING METHOD, AND NON-TRANSITORY STORAGE MEDIUM RECORDING PROGRAM

(71) Applicants: TOYOTA JIDOSHA KABUSHIKI KAISHA, Toyota-shi (JP); AISIN SEIKI KABUSHIKI KAISHA, Kariya-shi (JP)

(72) Inventors: Shinichiro FUJII, Kawasaki-shi (JP); Hiroe FUKUI, Toyohashi-shi (JP); Takashi GOTO, Okazaki-shi (JP); Tatsuya SHIGEKIYO, Okazaki-shi (JP); Kuniaki JINNAI, Nagoya-shi (JP); Naoto SASAGAWA, Nishio-shi (JP)

(73) Assignees: TOYOTA JIDOSHA KABUSHIKI KAISHA, Toyota-shi (JP); AISIN SEIKI KABUSHIKI KAISHA, Kariya-shi (JP)

(21) Appl. No.: 16/748,897

(22) Filed: Jan. 22, 2020

(30) Foreign Application Priority Data
Feb. 12, 2019 (JP) 2019-022707

(51) Int. Cl. G06Q 10/06; G05D 1/02; G06Q 30/02; G05D 1/00; B60R 11/04

(52) U.S. Cl. CPC G06Q 10/06315; G05D 1/0297; G05D 2201/0213; G05D 1/0088; B60R 11/04; G06Q 30/0203

(57) ABSTRACT

A server device, an information processing method, and a non-transitory storage medium recording a program are provided. The information processing device of the present disclosure, includes a control unit configured to execute providing, to a user device, information on an event in which mobile stores are installed, acquiring, based on a user response to the information on the event, information about demand for the event, and determining mobile objects constituting the mobile stores such that the size of each of the mobile stores is adjusted based on the acquired information about the demand.

### INCORPORATION BY REFERENCE

The disclosure of Japanese Patent Application No. 2019-022707 filed on Feb. 12, 2019 including the specification, drawings and abstract is incorporated herein by reference in its entirety.

### BACKGROUND

### 1. Technical Field

The present disclosure relates to an information processing device, an information processing method, and a non-transitory storage medium recording a program.

### 2. Description of Related Art

In commercial establishments, such as restaurants and retail stores, menus and products that customers prefer vary depending on, for example, the categories to which the customers visiting the establishments belong. Based on an analysis of the categories to which the customers visiting the establishments belong, improving menu items and product lineups is advantageous for stimulating improvement in customer satisfaction and increasing sales. For example, since a technology disclosed in Japanese Unexamined Patent Application Publication No. 2014-146154 identifies a customer category based on image information provided by a camera that captures images of customers entering an establishment through an entrance, it is possible to execute customer category identification for all customers visiting establishments.

### SUMMARY

As an example of a restaurant or a retail store, there is a mobile store opened for various events. At such a mobile store, menus, products, or the like, may be considered depending on customer preferences, in other words, customer demand. However, in an event where a plurality of mobile stores is opened, particularly in a one-time event, it is not easy to obtain information on customers who visited in the past. Therefore, the present disclosure provides an information processing device, an information processing method, and a non-transitory storage medium recording a program capable of bringing a state of a mobile store opened for an event close to demand from participants in the event.

A first aspect of the present disclosure relates to an information processing device including a control unit. The control unit is configured to execute providing, to a user device, information on an event in which one or more mobile stores are installed, acquiring, based on a user response to the information on the event, information about demand for the event, and determining one or more mobile objects constituting the one or more mobile stores such that the size of each of the one or more mobile stores is adjusted based on the acquired information about the demand for the event.

In the first aspect, determining the one or more mobile objects may include determining a kind of each of the one or more mobile stores and the size of each mobile store corresponding to the kind.

In the first aspect, determining the size may include determining the number of mobile objects constituting each of the mobile stores and the size of each of the mobile objects.

In the first aspect, the acquired information about the demand for the event may include information about demand for each of the one or more mobile stores. The control unit may determine the one or more mobile objects such that the size of the mobile store becomes larger as the demand for the mobile store indicated by the acquired information about the demand for each of the one or more mobile stores is higher.

In the first aspect, the control unit may increase the number of the mobile objects constituting the mobile store as the demand for the mobile store indicated by the acquired information about the demand for each of the one or more mobile stores increases.

In the first aspect, the control unit may execute acquiring the user response to the information on the event based on at least one of the total number of accesses to the information on the event, the number of accesses to information on each of the mobile stores included in the information on the event, and user evaluation of the information on the mobile stores included in the information on the event.

In the first aspect, each of the mobile objects may be autonomously travelable.

In the first aspect, the control unit may transmit a command to travel to a venue of the event to each of the determined mobile objects.

A second aspect of the present disclosure relates to an information processing method. The information processing method includes a step of providing, by at least one computer, to a user device, information on an event in which one or more mobile stores are installed, a step of acquiring, by the at least one computer, information about demand for the event based on a user response to the information on the event, and a step of determining, by the at least one computer, one or more mobile objects constituting the one or more mobile stores such that the size of each of the one or more mobile stores is adjusted based on the acquired information about the demand for the event.

In the second aspect, the step of determining the one or more mobile objects may include a step of determining a kind of each of the one or more mobile stores and the size of each mobile store corresponding to the kind.

In the second aspect, the step of determining the size may include a step of determining the number of mobile objects constituting each of the mobile stores and the size of each of the mobile objects.

In the second aspect, the acquired information on the demand for the event may include information on demand for each of the one or more mobile stores. The step of determining the one or more mobile objects may include a step of determining, by the at least one computer, the one or more mobile objects such that the size of the mobile store becomes larger as the demand for the mobile store indicated by the acquired information about the demand for each of the one or more mobile stores is higher.

In the second aspect, the step of determining the one or more mobile objects may include a step of increasing the number of the mobile objects constituting the mobile store as the demand for the mobile store indicated by the acquired information about the demand for each of the one or more mobile stores increases.

In the second aspect, the step of acquiring the information about the demand for the event may include a step of acquiring, by the at least one computer, the user response to the information on the event based on at least one of the total number of accesses to the information on the event, the number of accesses to information on each of the mobile stores included in the information on the event, and user evaluation of the information on each of the mobile stores included in the information on the event.

In the second aspect, the one or more mobile objects may be autonomously travelable.

In the second aspect, the information processing method may further include a step of transmitting, by the at least one computer, a command to travel to a venue of the event to the mobile objects.

Furthermore, a third aspect of the present disclosure relates to a non-transitory storage medium recording a program. The program is executable by at least one computer and configured to cause the at least one computer to execute providing, to a user device, information on an event in which one or more mobile stores are installed, acquiring, based on a user response to the information on the event, information about demand for the event, and determining one or more mobile objects constituting the one or more mobile stores such that the size of each of the mobile stores is adjusted based on the information about the demand for the event.

In the third aspect, determining the one or more mobile objects may include determining a kind of each of the one or more mobile stores and the size of each mobile store corresponding to the kind.

In the third aspect, determining the size may include determining the number of mobile objects constituting each mobile store and the size of each mobile object.

In the third aspect, the acquired information about the demand for the event may include information about demand for each of the one or more mobile stores. Determining the one or more mobile objects may include determining the one or more mobile objects such that a size of the mobile store becomes larger as the demand for the mobile store indicated by the acquired information about the demand for each of the one or more mobile stores is higher.

With each aspect of the present disclosure, it is possible to bring an opening state of a mobile store close to demand from participants in an event.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an operation example of a system according to one embodiment;

FIG. 2 is a block diagram schematically illustrating an example of constituent elements included in the system in FIG. 1;

FIG. 3 is a diagram illustrating a certain autonomous vehicle;

FIG. 4 is a flowchart illustrating a flow of processing of an information processing device in the system in FIG. 1;

FIG. 5 is an example of a user device screen in the system in FIG. 1;

FIG. 6 is an example of a table illustrating the number of accesses by each user to information on each mobile store in an event;

FIG. 7 is an example of a table illustrating demand for each mobile store in the event;

FIG. 8 is an example of a table illustrating user evaluation of the information on each mobile store in the event;

FIG. 9 is an example of a table illustrating the number of accesses to information on a product, or the like, at a certain store in the event;

FIG. 10 is an example of a table illustrating demand for a product, or the like, at the certain store in the event;

FIG. 11 is an example of a table illustrating demand for the event;

FIG. 12 is an example of a table illustrating a kind and the size of a store related to each autonomous vehicle; and

FIG. 13 is an example of a table illustrating the number and the sizes of autonomous vehicles which become each store.

### DETAILED DESCRIPTION OF EMBODIMENTS

Hereinafter, an information processing device, an information processing method thereof, and a non-transitory storage medium recording a program according to an embodiment of the present disclosure will be described with reference to drawings.

As an information processing device according to the present embodiment, a server device 200 is a computer on a network. The server device 200 is configured to be capable of communicating with an autonomous vehicle 100 (100A, 100B, . . . , 100n).

The autonomous vehicle 100 is also referred to as an electric vehicle (EV) palette. The autonomous vehicle 100 is a mobile object capable of autonomous traveling, autonomous driving, and unmanned driving, and has various sizes depending on its application. For example, the autonomous vehicle 100 having various sizes, from small vehicles that can be used instead of suitcases to large vehicles that can carry people and goods, can be used. In particular, in the present embodiment, the autonomous vehicle 100 can be used as a mobile store at an event. Examples of the mobile store may include a retail store, a restaurant, a shoe store, a clothing store, and a coffee shop.

The autonomous vehicle 100 includes an information processing device and a communication device that control the autonomous vehicle 100 itself, provide a user interface for a user of the autonomous vehicle 100, exchange information with various servers on the network, and the like. In addition to processing that can be executed by the autonomous vehicle 100 alone, the autonomous vehicle 100 provides the user with functions and services added by the various servers on the network in cooperation with them. Moreover, the autonomous vehicle 100 does not necessarily have to be an unmanned vehicle. For example, sales staff, customer service staff, security staff, and the like, may be on board. Further, the autonomous vehicle 100 does not necessarily have to be a vehicle capable of traveling completely autonomously. For example, the autonomous vehicle 100 may be driven or assisted in driving by a person depending on a situation. In the present embodiment, the autonomous vehicle 100 travels based on a predetermined operation command, and may, for example, pick up or deliver a package.

Furthermore, the autonomous vehicle 100 may have a function of receiving a request from the user, responding to the user, executing predetermined processing in response to the request from the user, and reporting the processing result to the user. In addition, the autonomous vehicle 100 may transmit, to the server device 200, a request which cannot be processed by the autonomous vehicle 100 alone among the requests from the user, and process the request in cooperation with the server device 200.

The server device 200 is configured to be capable of communicating with a user device 300 (300A, 300B, . . . , 300n). The user device 300 can receive an input of the user and an operation equivalent to the input, and transmit the input and the operation to the server device 200.

The server device 200 also serves as a device that instructs the autonomous vehicle 100 to travel. Based on information acquired from the user device 300, in particular, information on a response of the user, the server device 200 generates an operation command to be transmitted to the autonomous vehicle 100.

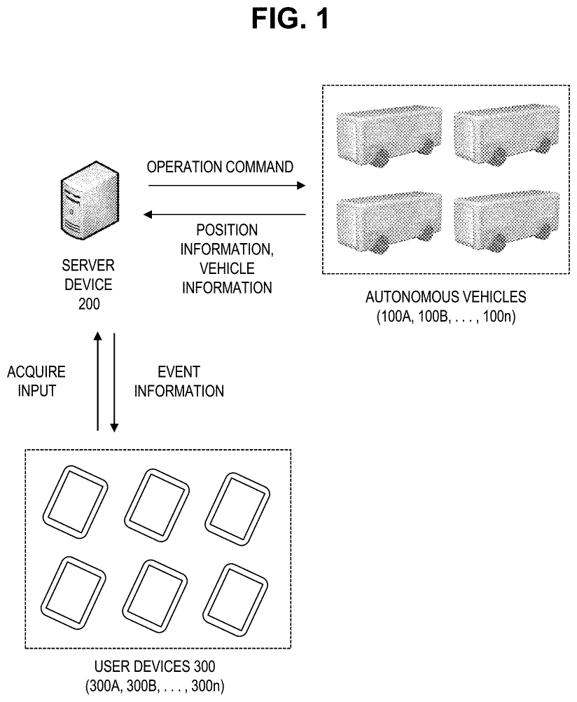

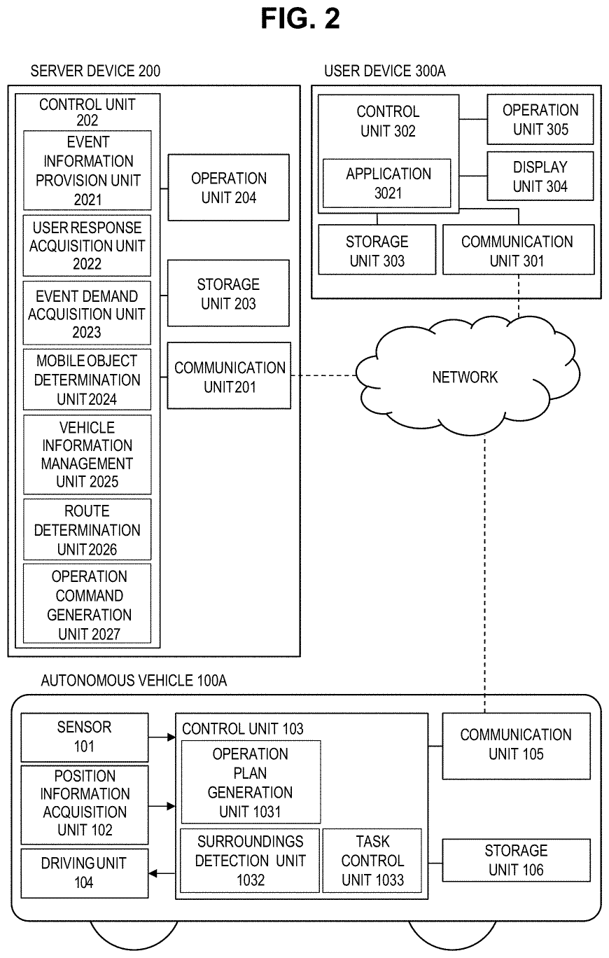

Each constituent element in the system in FIG. 1 will be described in detail. FIG. 2 is a block diagram schematically illustrating an example of a configuration of a system including the autonomous vehicles 100, the server device 200, and the user devices 300 illustrated in FIG. 1. In addition, although FIG. 2 illustrates an autonomous vehicle 100A from among a plurality of autonomous vehicles 100, other autonomous vehicles also have configurations similar to that of the autonomous vehicle 100A. Moreover, although FIG. 2 illustrates a user device 300A from among a plurality of user devices 300, other user devices also have configurations similar to that of the user device 300A.

The autonomous vehicle 100A travels according to an operation command acquired from the server device 200. Specifically, the autonomous vehicle 100A generates a traveling route based on the operation command acquired via wireless communication, and travels on a road in an appropriate manner while sensing the surroundings of the vehicle.

The autonomous vehicle 100A includes a sensor 101, a position information acquisition unit 102, a control unit 103, a driving unit 104, a communication unit 105, and a storage unit 106. The autonomous vehicle 100A is operated by power supplied from a battery.

The sensor 101 senses the surroundings of the vehicle, and typically includes a stereo camera, a laser scanner, a light detection and ranging, laser imaging detection and ranging (LIDAR), radar, and the like. The information acquired by the sensor 101 is transmitted to the control unit 103. The sensor 101 includes a sensor that supports autonomous traveling of the subject vehicle. The sensor 101 may include a camera mounted on the vehicle body of the autonomous vehicle 100. For example, the sensor 101 may include an image capturing device using an image sensor, such as a charged-coupled device (CCD), a metal-oxide-semiconductor (MOS), and a complementary metal-oxide-semiconductor (CMOS). A plurality of cameras may be mounted on a plurality of places on the vehicle body. For example, the cameras may be respectively mounted on the front, rear, right, and left sides of the vehicle body.

The position information acquisition unit 102 acquires a current position of the vehicle, and typically includes a global positioning system (GPS) receiver, and the like. The information acquired by the position information acquisition unit 102 is transmitted to the control unit 103. The GPS receiver as a satellite signal receiver receives signals from a plurality of GPS satellites. Each GPS satellite is an artificial satellite that orbits the earth. A satellite positioning system, that is, a navigation satellite system (NSS) is not limited to the GPS. Position information may be detected based on signals from various satellite positioning systems. The NSS is not limited to a global navigation satellite system, and may include a quasi-zenith satellite system, such as “Galileo” in Europe and “Michibiki,” operated with a GPS in an integrated manner, in Japan.

The control unit 103 is a computer that controls the autonomous vehicle 100A based on information acquired from the sensor 101, the position information acquisition unit 102, and the like. The control unit 103 is an example of a controller that receives an operation command from the server device 200 and controls traveling of the autonomous vehicle 100A, which is a mobile object.

The control unit 103 includes a CPU and a main storage unit, and executes information processing though a program. The CPU is also referred to as a processor. The main storage unit of the control unit 103 is an example of a main storage device. The CPU of the control unit 103 executes a computer program that is deployed in an executable manner in the main storage unit, and provides various functions. The main storage unit of the control unit 103 stores the computer program executed by the CPU, data, or the like. Examples of the main storage unit of the control unit 103 include a dynamic random access memory (DRAM), a static random access memory (SRAM), and a read-only memory (ROM).

The control unit 103 is connected to the storage unit 106. The storage unit 106, a so-called external storage unit, is used as a storage area that assists the main storage unit of the control unit 103, and stores the computer program executed by the CPU of the control unit 103, data, or the like. Examples of the storage unit 106 include a hard disk drive and a solid state drive (SSD).

The control unit 103 includes, as functional modules, an operation plan generation unit 1031, a surroundings detection unit 1032, and a task control unit 1033. Each functional module may be implemented by executing, via the control unit 103, that is, the CPU of the control unit 103, a program stored in the main storage unit or the storage unit 106.

The operation plan generation unit 1031 acquires the operation command from the server device 200, and generates an operation plan for the subject vehicle. In the present embodiment, the operation plan is data that defines a route along which the autonomous vehicle 100A travels, and processing executed by the autonomous vehicle 100A in a part of or the whole of the route. Examples of the data included in the operation plan will be described below.

(1) Data Representing Route Along which Subject Vehicle Travels as Set of Road Links

The route along which the subject vehicle travels may be automatically generated based on a given departure place and destination with reference to, for example, map data stored in the storage unit 106. Further, the route may be generated by using an external service.

(2) Data Representing Processing to be Executed by Subject Vehicle at Point on Route

Examples of processing to be executed by the subject vehicle on the route include, but are not limited to, “functioning as a mobile store”, “receiving a designated package”, “delivering a designated package”, and “receiving a receipt or a claim check”. The operation plan generated by the operation plan generation unit 1031 is transmitted to the task control unit 1033 to be described below.

The surroundings detection unit 1032 detects the surroundings of the vehicle based on the data acquired by the sensor 101. Examples of objects to be detected include, but are not limited to, the number or positions of lanes, the number or positions of other vehicles around the subject vehicle, the number or positions of obstacles (for example, pedestrians, bicycles, structures, or buildings) around the subject vehicle, the structure of roads, and road signs. The objects to be detected may be whatever is necessary for autonomous traveling. Furthermore, the surroundings detection unit 1032 may track a detected object. For example, the surroundings detection unit 1032 may obtain a relative speed of an object from a difference between the coordinates of the object detected in the previous step and the current coordinates of the object. The data on surroundings (hereinafter, the surroundings data) detected by the surroundings detection unit 1032 is transmitted to the task control unit 1033 to be described below.

The task control unit 1033 controls traveling of the subject vehicle based on the operation plan generated by the operation plan generation unit 1031, the surroundings data generated by the surroundings detection unit 1032, and position information of the subject vehicle acquired by the position information acquisition unit 102. For example, the task control unit 1033 controls the subject vehicle such that the subject vehicle travels along a predetermined route and an obstacle does not enter a predetermined safety area around the subject vehicle. A well-known method may be employed as a method of causing the vehicle to autonomously travel. Furthermore, the task control unit 1033 may execute tasks other than traveling based on the operation plan generated by the operation plan generation unit 1031. Examples of the tasks may include receiving a package from the user, and issuing a receipt and a claim check. Part or all of the task control unit 1033 may be referred to as a traveling control unit.

The driving unit 104 causes the autonomous vehicle 100A to travel based on a command generated by the task control unit 1033. The driving unit 104 includes, for example, a motor, an inverter, a brake, a steering mechanism, and a secondary battery that are used to drive the autonomous vehicle 100A.

The communication unit 105 is a communication tool that connects the autonomous vehicle 100A to the network. In the present embodiment, the autonomous vehicle 100A can communicate with other devices, for example, the server device 200, via the network. In addition, the communication unit 105 may further include a communication tool via which the autonomous vehicle 100A, which is the subject vehicle, can execute inter-vehicle communication with other autonomous vehicles 100 (100B, . . . , 100n).

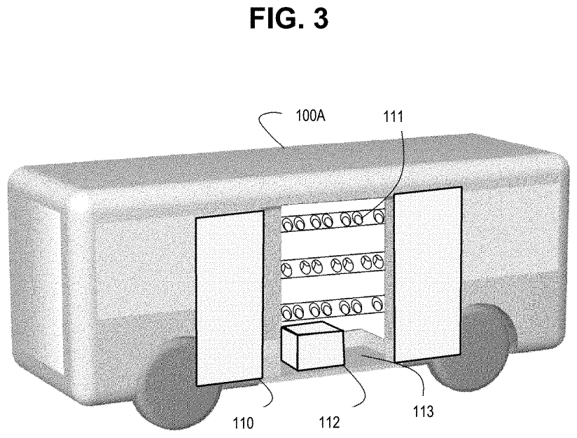

The autonomous vehicle 100 may have a package loading structure, a product display shelf, or a cooking room. As illustrated in FIG. 3, the autonomous vehicle 100A among the autonomous vehicles 100 is in a state where a door 110 is opened, that is, the vehicle cabin is visible from the outside. The autonomous vehicle 100A is configured to function as a mobile store handling shoes. A package loading unit 113 is installed inside the autonomous vehicle 100A, and loaded with a plurality of shoes 111, and the like, arranged on the product display shelf, and packages 112, such as shoes. The autonomous vehicle 100A may have a configuration other than the above configuration. The autonomous vehicle 100A may include a mechanism that hands over only a designated package among a plurality of packages. For example, a storage device having a plurality of storage compartments (also referred to as blocks) may be provided in the vehicle cabin and only permitted blocks may be unlocked. Further, the autonomous vehicle 100A may include a mechanism that hands over the loaded package to another device. For example, the autonomous vehicle 100A may include a mechanism that is connected to an external storage device, such as a delivery locker, and transfers a package. In addition, the autonomous vehicle 100A may include a device that issues a receipt or a claim check. The above-described mechanisms or devices are controlled by the task control unit 1033.

Next, the server device 200 will be described. The server device 200 provides the information on the event to the user device 300. In addition, the server device 200 acquires, from the user device 300, the response of the user (hereinafter, the user response) to the provided information on the event, and acquires the demand for the event. Then, the server device 200 determines the mobile object to be used as the mobile store such that the size of each mobile store in the event can be adjusted based on the acquired demand for the event. When determining the mobile object to be used as the mobile store, the server device 200 determines the kind of the mobile store and the size of each kind of store. Furthermore, when determining the size of the store, the server device 200 determines the number of autonomous vehicles 100, which are mobile objects to be used as the mobile store, and the size of each of the autonomous vehicles 100. The server device 200 also manages the positions and the states of the plurality of autonomous vehicles 100, and transmits the operation command. The server device 200 transmits the operation command to travel to the corresponding event venue to each of the determined autonomous vehicles 100.

The server device 200 includes a communication unit 201, a control unit 202, and a storage unit 203. The communication unit 201 is similar to the communication unit 105 and includes a communication tool that connects the server device 200 to the network. In addition, the server device 200 is a communication interface that communicates with the autonomous vehicles 100 via the network. Similar to the control unit 103, the control unit 202 includes a CPU and a main storage unit, and executes information processing through a program. The CPU is also a processor, and the main storage unit of the control unit 202 is an example of a main storage device. The CPU of the control unit 202 executes a computer program that is deployed in an executable manner in the main storage unit, and provides various functions. The main storage unit of the control unit 202 stores the computer program executed by the CPU, data, or the like. The main storage unit of the control unit 202 is a DRAM, an SRAM, a ROM, or the like

The control unit 202 is connected to the storage unit 203. The storage unit 203, an external storage unit, is used as a storage area that assists the main storage unit of the control unit 202, and stores the computer program executed by the CPU of the control unit 202, data, or the like. The storage unit 203 is a hard disk drive, an SSD, or the like.

The control unit 202 controls the server device 200. The control unit 202 includes, as functional modules, an event information provision unit 2021, a user response acquisition unit 2022, an event demand acquisition unit 2023, a mobile object determination unit 2024, a vehicle information management unit 2025, a route determination unit 2026, and an operation command generation unit 2027. Each functional module may be implemented by executing, via the CPU of the control unit 202, a program (according to an embodiment of the present disclosure) stored in the main storage unit or the storage unit 203.

The event information provision unit 2021 provides, to the user device 300, the information on the event (hereinafter, event information), input from the operation unit 204, such as an input unit, of the server device 200, and stored in the storage unit 203, and the like, or the event information acquired according to a predetermined program. The event information includes information on the store opened for the event in addition to an event date and time, an event venue, and the like. The information on the store includes the kind of the store. The kind of the store may mean whether the store is a shoe store, a clothing store, a coffee shop, or the like. Further, the event information may include the specific content of products or services (hereinafter, products, or the like) that each store handles. For example, in a case of a shoe store, the event information may include the kind of shoe to be exhibited, shoe manufacturer, shoe size, shoe photo, or the like.

The user response acquisition unit 2022 acquires, via the network, the user response transmitted from the user device 300, specifically, information corresponding to the user response. The information corresponding to the user response is information input from the user device 300 with respect to the event information provided from the server device 200 to the user device 300. For example, the user response includes the number of accesses to the event information, the number of accesses to information on each store included in the event information, and the user evaluation of the information on each store included in the event information. The information on each store included in the event information may include information on products, or the like, at each store.

The event demand acquisition unit 2023 acquires the demand for the event based on the user response acquired by the user response acquisition unit 2022. Examples of the demand for the event may include the demand for the event itself based on the user response, the demand for each store, the demand for products, or the like, at each store. For example, by comparing the total number of accesses to the event information with a predetermined value, the event demand acquisition unit 2023 can estimate the demand for the event, in other words, whether the number of visitors is large or small. In addition, by comparing the number of accesses to the information on each store included in the event information with the total number of accesses to the event information, the event demand acquisition unit 2023 can estimate the demand for each store, in other words, whether the number of visitors to each store is large or small. Moreover, by further adding the user evaluation of the information on each store included in the event information, the event demand acquisition unit 2023 can correct the estimated demand for each store. Furthermore, by comparing the number of accesses to products, or the like, at each store with the number of accesses to the information on each store, the demand for each of products, or the like, at each store can be estimated.

The mobile object determination unit 2024 determines the mobile object, specifically, the autonomous vehicle 100 to be used as the store, that is, the mobile store such that the size of each store is adjusted based on various demands for the event estimated, that is, acquired, by the event demand acquisition unit 2023. Determining the autonomous vehicle 100 includes determining the kind of the mobile store and the size of each kind of store. In addition, determining the store size includes determining the number of autonomous vehicles 100 to be used as mobile stores, and the size of each autonomous vehicle 100. The mobile object determination unit 2024 can determine the mobile object, that is, the autonomous vehicle 100 such that the higher the acquired demand for the mobile store is, the larger the store size becomes. Moreover, the mobile object determination unit 2024 can increase the number of mobile objects as the acquired demand for the mobile store. When each autonomous vehicle 100 has a predetermined size and the kind of the store is predetermined for each autonomous vehicle 100, the mobile object determination unit 2024 determines which autonomous vehicle 100 is to be used for the event.

The vehicle information management unit 2025 manages the plurality of autonomous vehicles 100. Specifically, at predetermined intervals, the vehicle information management unit 2025 receives information, such as data, on the autonomous vehicle 100 from the plurality of autonomous vehicles 100, and stores the received information in the storage unit 203. The position information and the vehicle information are used as the information on the autonomous vehicle 100. Examples of the vehicle information includes an identifier, usage, a kind, information on a standby point (a garage or a sales office), a door type, a vehicle body size, a package compartment size, a loading amount, a travelable distance when fully charged, a travelable distance at the current time, and a current status of the autonomous vehicle 100. However, the vehicle information may be information other than the above. In addition, the current status includes the kind of the store, and the amount or kind of the loaded products, or the like.

The route determination unit 2026 determines a traveling route on which the autonomous vehicle 100, determined by the mobile object determination unit 2024, travels to the event venue. For example, when the determined autonomous vehicle 100 does not have a sufficient amount of products, the route determination unit 2026 determines a route stopping at a predetermined warehouse, or the like, to restock the products on the way to the event venue. Alternatively, the route determination unit 2026 determines a route stopping at a home of a staff member, or the like, so that the staff member of the mobile store using the determined autonomous vehicle 100 can board thereon on the way to the event venue. In addition, the package 112 illustrated in FIG. 3 is loaded at the warehouse on the way to the event venue.

The operation command generation unit 2027 generates the operation command that causes the mobile object determined by the mobile object determination unit 2024, that is, the autonomous vehicle 100, to travel to the event venue according to the route determined by the route determination unit 2026. In addition, the operation command generation unit 2027 transmits the generated operation command to the autonomous vehicle 100 and instructs the autonomous vehicle 100 to travel.

Next, the user device 300 will be described. Examples of the user device 300 include a mobile terminal, a smartphone, and a personal computer. As an example, the user device 300A in FIG. 2 may include a communication unit 301, a control unit 302, and a storage unit 303. Since the communication unit 301 and the storage unit 303 of the user device 300A are similar to the communication unit 201 and the storage unit 203 of the server device 200, description thereof is omitted. Furthermore, the user device 300A includes a display unit 304 and an operation unit 305. Examples of the display unit 304 include a liquid crystal display and an electroluminescence panel. Examples of the operation unit 305 may include a keyboard and a pointing device. More specifically, in the present embodiment, the operation unit 305 includes a touch panel.

Similar to the control unit 202, the control unit 302 includes a CPU and a main storage unit. The CPU of the control unit 302 executes an application program (hereinafter, application 3021) deployed in the storage unit 303. The application 3021 is an application program that accesses the event information distributed from, for example, a web browser or the server device 200. The application 3021 having a GUI, receives a user input (for example, access to the event information), and transmits the input to the server device 200 via the network.

In addition, in FIG. 2, the autonomous vehicle 100, the server device 200, and the user device 300 are connected to the same network. However, the network connecting the autonomous vehicle 100 and the server device 200 may be different from the network connecting the server device 200 and the user device 300.

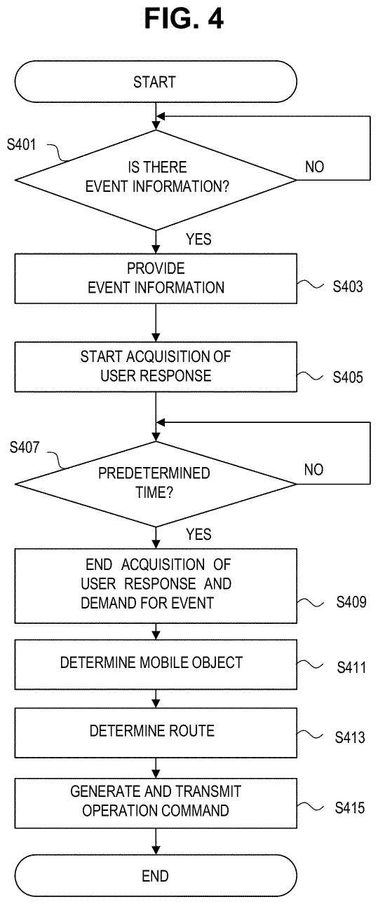

The processing on the system having the above configuration will be described with reference to the flowchart illustrated in FIG. 4. In addition, the flowchart in FIG. 4 illustrates the flow of information processing by the server device 200.

In step S401, the control unit 202, particularly the event information provision unit 2021, of the server device 200 determines whether the event information is present. When the event information is input to the server device 200 and stored in the storage unit 203, and the like, or when the event information acquired via the network according to a predetermined program is stored, an affirmative determination is made in step S401. Furthermore, when the affirmative determination is made in step S401, the event information is provided to the user device 300 in step S403. Here, specifically, the event information provision unit 2021 of the control unit 202 provides the event information to the user device 300 by posting or announcing the event information on a website for the event on the Internet accessible by the user device 300. Moreover, the server device 200 may directly transmit, to the user device 300, a notification or signal that notifies of the event information in order to reliably notify the user device 300 of the announcement of the event information. When step S403 is executed, acquisition of the user response is started in step S405.

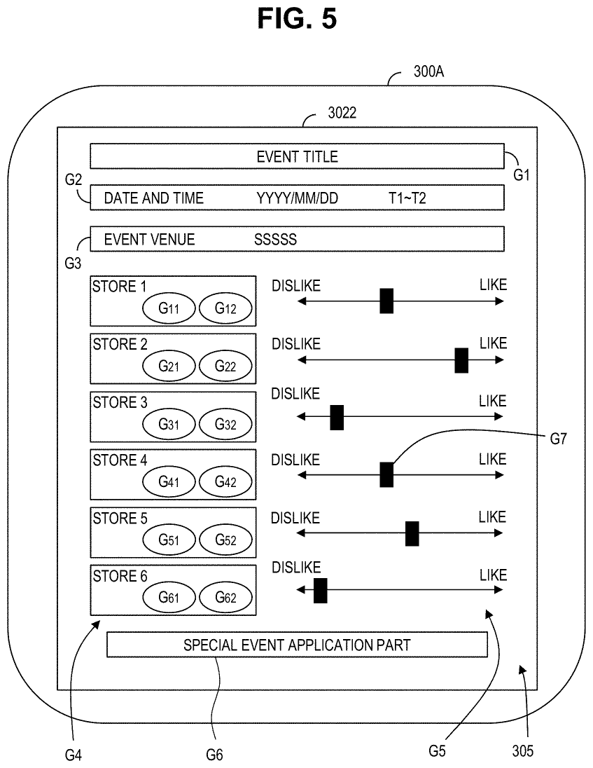

Here, FIG. 5 illustrates, as an example, the user device 300A displaying the provided event information. The control unit 302 of the user device 300A executes the application 3021, and displays a screen 3022 illustrated in FIG. 5. The screen 3022 displays, as the event information, an event title G1, an event date and time G2, an event venue G3, information G4 on the mobile store, that is, the store opened for the event, a user evaluation input part G5 for the information on each store, and a special event application part G6. The information on the opened stores may include store names, such as stores 1 to 5, information on products, or the like, at each store, such as products G₁₁, G₁₂ at the store 1. As stated above, the information on the opened store includes information on products or services at each store. Therefore, this is equivalent to displaying the kind of store on the user device 300A.

In the user device 300A on which the screen 3022 in FIG. 5 is displayed, the user can execute various inputs by screen operations on the operation unit 305, which is a touch panel. For example, the user can view the content of the product G₁₁ on a separate screen by touching the product G₁₁ at the store 1 on the screen 3022 in FIG. 5. Furthermore, the user can input evaluation (user evaluation) of each store by touching and moving a moving icon G7 in user evaluation input part G5. The user input, that is, the response, on the event information, such as the number of accesses to a product, and the like, which is the information on the store, is transmitted to the server device 200 via the network.

The user input on the event information transmitted to the server device 200 is acquired by the user response acquisition unit 2022 of the control unit 202 as the user response to the event information, and stored in the storage unit 203. When the input is stored in the storage unit 203, user information, such as the ID of the user device 300A, is attached to the user response to the event information. The acquisition of the user response is continuously executed until an affirmative determination that the predetermined time has arrived is made in step S407. In addition, the predetermined time in step S407 is determined as a time before a deadline when the mobile object, that is, the autonomous vehicle 100, can be dispatched to the event according to determination of the mobile object, to be described below. For example, one day before (24 hours before) the event date and time may be determined as the predetermined time.

When the predetermined time has arrived and the affirmative determination is made in step S407, acquisition of the user response ends in step S409, and acquisition of information on the demand for the event is executed. Hereinafter, the information on demand is also simply referred to as demand. The acquisition of the demand for the event is executed by the event demand acquisition unit 2023 of the control unit 202. Examples of the demand for the event include the demand for the event itself, the demand for each store, and the demand for products or services at each store based on the user response.

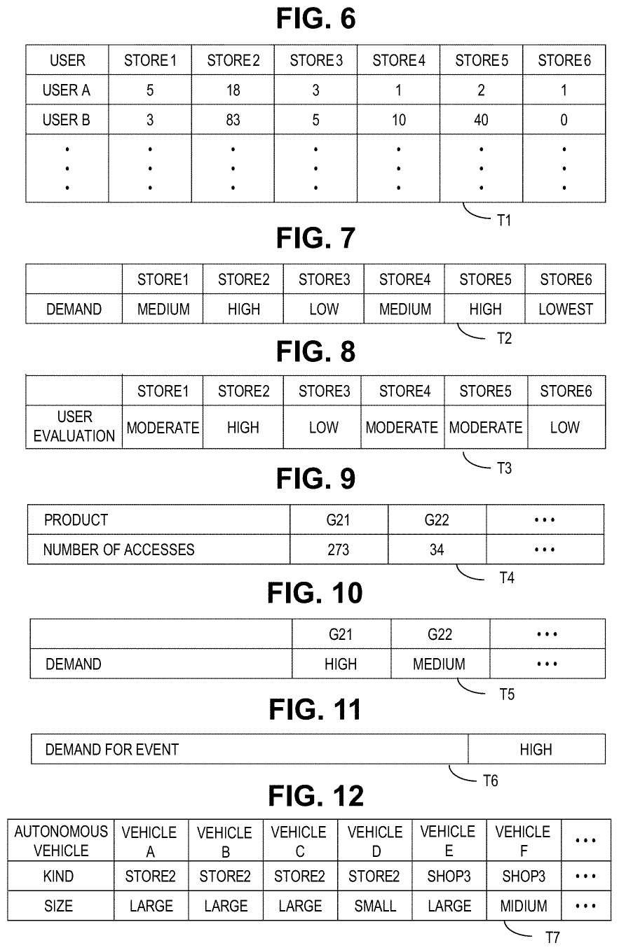

Here, FIG. 6 illustrates a table T1, as an example, in which the number of accesses to the information on each store, that is, each mobile store, by every user is stored. Moreover, a user A is a user ID of the user device 300A, and a user B is a user ID of a user device 300B. The data in the table T1 is constructed by the acquisition of user responses. The event demand acquisition unit 2023 of the control unit 202 acquires the demand for the event itself from the number of people that the event venue can accommodate and the total number of accesses to the event information. For example, when the total number of accesses to the event information with respect to the number of people that the event venue can accommodate is greater than or equal to a first predetermined value, the demand “high” is acquired as the demand for the event itself. Furthermore, when the number of accesses to the information on a specific store with respect to the total number of accesses, that is, the proportion of accesses to the information on a specific store in the total number of accesses to the event information, is greater than or equal to a second predetermined value, the demand “high” is acquired as the demand for the specific store. In the table T1 in FIG. 6, the number or the proportion of accesses to the information on a store 2 is greater than those of the other stores 1, and 3 to 6. Therefore, the demand “high” is acquired as the demand for the store 2. On the other hand, in the table T1 in FIG. 6, the number or the proportion of accesses to the information on the store 6 is less than those of the other stores 1 to 5. Therefore, the demand “low” is acquired as the demand for the store 6. The demand acquired in the above manner is stored in a table T2 in the storage unit 203 illustrated in FIG. 7 by the event demand acquisition unit 2023 of the control unit 202. In addition, the data in the table T2 in FIG. 7 may be corrected based on data in a table T3 illustrated in FIG. 8, that is, user evaluation of all users input from the user evaluation input part G5. For example, in an estimation of the demand for a store with low user evaluation, when the demand is almost on the border of a three-stage evaluation system of “high”, “moderate”, and “low”, it can be estimated that the demand is low.

Further, the event demand acquisition unit 2023 of the control unit 202 also acquires information on each store, specifically, the demand for products or services. FIG. 9 illustrates a table T4, as an example, in which the number of accesses to products G₂₁, G₂₂, . . . , at the store 2 from all users is stored. The data in the table T4 corresponds to the user response to the information on the store 2. Based on data in FIG. 9, the event demand acquisition unit 2023 of the control unit 202 acquires the demand for the products, or the like, at the store 2. For example, the number of accesses to the product G₂₁ is extremely large, with respect to the total number of accesses to information on products, or the like, at the store 2. In other words, the proportion of accesses to the product G₂₁ among the products, or the like, at the store 2 is greater than or equal to a third predetermined value. Therefore, as illustrated in a table T5 in FIG. 10, the event demand acquisition unit 2023 of the control unit 202 acquires the demand “high” as the demand for the product G₂₁ among the products, or the like, at the store 2.

Moreover, the event demand acquisition unit 2023 of the control unit 202 can estimate the demand for the event based on the user input from the special event application part G6. When the number of applications for the special event, that is, the number of ticket purchases, is, for example, greater than or equal to a predetermined value, it can be estimated that the number of visitors to the event is large. In other words, the demand for the event is estimated and acquired in consideration of the number of ticket purchases and the total number of accesses to event information. For example, when the total number of accesses to event information is greater than or equal to a fourth predetermined value, and the number of ticket purchases is greater than or equal to a fifth predetermined value, the demand “high” is acquired as the demand for the event, as illustrated in a table T6 in FIG. 11.

When various demands for the event are acquired, in step S411, processing of determining the autonomous vehicle 100 as a mobile object is executed. Determining the autonomous vehicle 100 is executed by the mobile object determination unit 2024 of the control unit 202. The sizes of the autonomous vehicles 100 may vary from being, for example, large, medium to small. In addition, the autonomous vehicle 100 includes vehicles having various current statuses, that is, vehicles to be used as various stores. Therefore, the mobile object determination unit 2024 determines the autonomous vehicle 100 such that the size of each mobile store for the event is adjusted based on the demand for the event, the demand for each store, and the demand for products, or the like, at each store, which are acquired in step S409.

The mobile object determination unit 2024 of the control unit 202 determines the autonomous vehicle 100 to be used as a mobile store based on the various demands that has been already acquired and the current status of each autonomous vehicle 100, in particular, the kind and size of the store managed by the vehicle information management unit 2025, as illustrated in a table T7 in FIG. 12. In step S411, determining the autonomous vehicle 100 as the mobile object includes determining the kind of the mobile store and the size of each kind of store. In addition, determining the store size includes determining the number of mobile objects to be used as mobile stores, and the size of each mobile store. Further, the autonomous vehicle 100 to be used as a mobile store is determined by a program, or the like, that is determined or learned in advance such that a store space can be provided in good balance based on the demand. More specifically, the autonomous vehicle 100 to be used as a mobile store is determined based on the demand for the event, the demand for each store, and/or the demand for products, or the like, handled at each mobile store such that a store space may be provided in a good balance.

In the present embodiment, the demand for the event is “high” (refer to FIG. 11), the demand for the store 2 is “high” (refer to FIG. 7), and the demand for the product G₂₁ among the products, or the like, handled at the store 2 is “high” (refer to FIG. 10). Therefore, the size of the store 2 is adjusted such that the store 2 is wider than the other stores 1, and 3 to 6. Specifically, three large autonomous vehicles 100 are determined as the autonomous vehicles 100 to be used as the store 2. With reference to FIGS. 3 and 12, the store 2 handles shoes, and the autonomous vehicles 100A, 100B, 100C are respectively large autonomous vehicles. Here, the three autonomous vehicles 100A, 100B, 100C, including the autonomous vehicle 100A as illustrated in FIG. 3, are determined as the mobile objects, that is, the autonomous vehicles 100 to be used as the store 2.

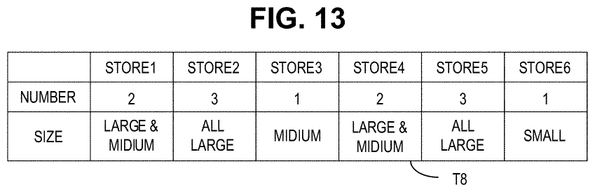

On the other hand, when the demand for the store 6 is the lowest among the demands for the stores 1 to 6, or the demand for the store 6 itself is low or almost absent (refer to FIG. 7), one small autonomous vehicle 100m is determined as the autonomous vehicle 100 to be used as the store 6. Moreover, when the demand for the store 4 is “medium” (refer to FIG. 7), one medium-sized autonomous vehicle and one large autonomous vehicle are determined as the autonomous vehicles 100 to be used as the store 4. Since the space for opening a mobile store in the entire event is usually determined in advance, it is desirable that various mobile stores can open within the space for opening. Therefore, the size, and the like, of the autonomous vehicle 100 to be used as these various stores may be determined in consideration of not only various demands but also the space for opening. In addition, the kind of the product, and the like, may also be considered. As an example, a table T8 illustrated in FIG. 13 shows the number and sizes of the autonomous vehicles 100 to be used as each store. At each store, the number and sizes of autonomous vehicles 100 to be used as the mobile store are combined based on the demand for each store, but the present disclosure is not limited thereto. It is possible to set the sizes of all autonomous vehicles 100 to be substantially the same and to simply increase the number of the autonomous vehicles 100 to be used as the mobile store as the demand for the corresponding store increases. Conversely, it is possible to set the number of autonomous vehicles 100 which are used as each mobile store to be the same and to simply increase the sizes of autonomous vehicles 100 to be used as the mobile store as the demand for the corresponding store increases.

In this manner, when the autonomous vehicles 100 to be used as mobile stores are determined, the route determination unit 2026 of the control unit 202 determines the route for each autonomous vehicle 100 in step S413. For example, it is assumed that the autonomous vehicles 100A to 100C are determined to be used as the mobile store 2, which is a shoe store. In this case, it is further assumed that the amount of the product G₂₁, having a high demand among the products, or the like, at the store 2, is insufficient in the autonomous vehicles 100A to 100C. In such a case, each route for the autonomous vehicles 100A to 100C is determined so that the autonomous vehicles 100A to 100C can travel to a warehouse, or the like, where the product G₂₁ is stored, before traveling to the event venue. This route is determined such that the autonomous vehicles 100A to 100C travel from the current location and stop at the warehouse on the way to the event venue.

In step S415, the operation command generation unit 2027 generates the operation command and transmit the generated operation command to each of the autonomous vehicles 100 determined in step S411 such that the determined autonomous vehicles 100 travel to the event venue according to the route determined in step S413.

The operation command is acquired by the operation plan generation unit 1031 of the autonomous vehicle 100. Accordingly, as described above, the operation plan generation unit 1031 generates the operation plan for the subject vehicle. Then, as described above, each autonomous vehicle 100 can travel to the event venue. The traveling is executed by the task control unit 1033 described above, and the like.

Therefore, the autonomous vehicles 100 that function as the mobile stores 1 to 6 are dispatched to the event venue at the event date and time. Then, the dispatched autonomous vehicles 100 function as the determined mobile stores. In this manner, since the autonomous vehicle 100 to be used as the mobile store is determined based on the demand for the event depending on the user response, it is possible to bring the operating state of the mobile store close to the demand from the participants, that is, the visitors, in the event. Therefore, the event itself can be a thriving event, and the satisfaction of the visitors, can be suitably increased.

In the embodiment, the demand for the event was acquired based on user response, and the autonomous vehicle 100 that is the mobile object, is determined based on the acquired demand. Although the user response is the number of accesses as described above, the age, the gender, or the like, of the user who uses the user device 300, that is, the attribute of the accessing user, may be considered in acquiring the demand for the event. These may be acquired by prompting the user to input at the time of initial access to the event information, or acquired from the user ID of the user device 300.

Moreover, in the embodiment, although the demand for the event is acquired based on the user response to the event information, the demand for the event may be acquired based on other information. For example, a website for survey may be attached to the event information, and the demand for the event may be acquired based on the survey result. Further, history information on a similar event may be acquired via the network, and used for acquisition of the demand for the event.

The embodiment is merely an example, and appropriate modifications may be executed within the technical scope of the disclosure. The processes or elements described in the present disclosure may be freely combined and executed as long as no technical contradiction occurs.

Further, the processing described as being executed by one device may be executed in a shared manner by a plurality of devices. For example, the server device 200 that is an information processing device does not have to be one computer, and may be configured as a system including a plurality of computers. Alternatively, the processing described as being executed by different devices may be executed by one device. In the computer system, the hardware configuration (the server configuration) that implements each function can be flexibly changed.

The present disclosure can also be implemented by supplying a computer program having the functions described in the above embodiment to a computer, and reading and executing the program by one or more processors included in the computer. Such a computer program may be provided to the computer by a non-transitory computer-readable storage medium that can be connected to the computer system bus, or provided to the computer via the network. Examples of the non-transitory computer-readable storage medium include any kind of disk, such as a magnetic disk (a floppy® disk, a hard disk drive (HDD), and the like), an optical disk (a CD-ROM, a DVD disk, a Blu-ray disk, and the like), a read-only memory (ROM), a random access memory (RAM), an EPROM, an EEPROM, a magnetic card, a flash memory, an optical card, and any kind of medium suitable for storing electronic commands.

What is claimed is:

1. An information processing device comprising:
a control unit configured to execute:
providing, to a user device, information on an event in which one or more mobile stores are installed;
acquiring, based on a user response to the information on the event, information about demand for the event; and
determining one or more mobile objects constituting the one or more mobile stores such that a size of each of the one or more mobile stores is adjusted based on the acquired information about the demand for the event.

2. The information processing device according to claim 1, wherein determining the one or more mobile objects includes determining a kind of each of the one or more mobile stores and the size of each of the mobile stores corresponding to the kind.

3. The information processing device according to claim 2, wherein determining the size includes determining the number of mobile objects constituting each of the mobile stores and a size of each of the mobile objects.

4. The information processing device according to claim 1, wherein:
the acquired information about the demand for the event includes information about demand for each of the one or more mobile stores, and
the control unit is configured to determine the one or more mobile objects such that the size of the mobile store becomes larger as the demand for the mobile store indicated by the acquired information about the demand for each of the one or more mobile stores is higher.

5. The information processing device according to claim 4, wherein the control unit is configured to increase the number of the mobile objects constituting the mobile store as the demand for the mobile store indicated by the acquired information about the demand for each of the one or more mobile stores increases.

6. The information processing device according to claim 1, wherein the control unit is configured to execute acquiring the user response to the information on the event based on at least one of a total number of accesses to the information on the event, the number of accesses to information on each of the mobile stores included in the information on the event, and user evaluation of the information on each of the mobile stores included in the information on the event.

7. The information processing device according to claim 1, wherein each of the mobile objects is configured to be autonomously travelable.

8. The information processing device according to claim 1, wherein the control unit is configured to transmit a command to travel to a venue of the event to each of the determined mobile objects.

9. An information processing method comprising:
providing, by at least one computer, to a user device, information on an event in which one or more mobile stores are installed;
acquiring, by the at least one computer, information about demand for the event based on a user response to the information on the event; and
determining, by the at least one computer, one or more mobile objects constituting the one or more mobile stores such that a size of each of the one or more mobile stores is adjusted based on the acquired information about the demand for the event.

10. The information processing method according to claim 9, wherein determining the one or more mobile objects includes determining a kind of each of the one or more mobile stores and the size of each of each mobile store corresponding to the kind.

11. The information processing method according to claim 10, wherein determining the size includes determining the number of mobile objects constituting each of the mobile stores and a size of each of the mobile objects.

12. The information processing method according to claim 9, wherein:
the acquired information about the demand includes information about demand for each of the one or more mobile stores, and
determining the one or more mobile objects includes determining, by the at least one computer, the one or more mobile objects such that the size of the mobile store becomes larger as the demand for the mobile store indicated by the acquired information about the demand for each of the one or more mobile stores is higher.

13. The information processing method according to claim 12, wherein determining the one or more mobile objects includes increasing the number of the mobile objects constituting the mobile store as the demand for the mobile store indicated by the acquired information about the demand for each of the one or more mobile stores increases.

14. The information processing method according to claim 9, wherein acquiring the information about the demand for the event includes acquiring, by the at least one computer, the user response to the information on the event based on at least one of a total number of accesses to the information on the event, the number of accesses to information on each of the mobile stores included in the information on the event, and user evaluation of the information on each of the mobile stores included in the information on the event.

15. The information processing method according to claim 9, wherein the one or more mobile objects are configured to be autonomously travelable.

16. The information processing method according to claim 15, further comprising:
transmitting, by the at least one computer, a command to travel to a venue of the event to the mobile objects.

17. A non-transitory storage medium recording a program that is executable by at least one computer and configured to cause the at least one computer to execute:
providing, to a user device, information on an event in which one or more mobile stores are installed;
acquiring, based on a user response to the information on the event, information about demand for the event; and
determining one or more mobile objects constituting the one or more mobile stores such that a size of each of the one or more mobile stores is adjusted based on the information about the demand for the event.

18. The non-transitory storage medium recording program according to claim 17, wherein determining the one or more mobile objects includes determining a kind of each of the one or more mobile stores and the size of each mobile store corresponding to the kind.

19. The non-transitory storage medium recording program according to claim 18, wherein determining the size includes determining the number of mobile objects constituting each of the mobile stores and the size of each of the mobile objects.

20. The non-transitory storage medium recording program according to claim 17, wherein:
the acquired information on the demand for the event includes information about demand for each of the one or more mobile stores; and
determining the one or more mobile objects includes determining the one or more mobile objects such that a size of the mobile store becomes larger as the demand for the mobile store indicated by the acquired information about the demand for each of the one or more mobile stores is higher.
